(19) United States
(12) Patent Application Publication
(10) Pub. No.: US 2026/0217914 A1
(43) Pub. Date: Jul. 30, 2026

(54) ISOCYANATE-FREE AND BPA-FREE CO-POLY(URETHANE-CARBONATE)

(71) Applicant: CYCLICOR AB, Lund (SE)

(72) Inventors: Sang Hyun PYO, Staffanstorp (SE); Rajni HATTI KAUL, Lund (SE)

(73) Assignee: CYCLICOR AB, Lund (SE)

(21) Appl. No.: 19/141,535

(22) PCT Filed: Dec. 15, 2023
(86) PCT No.: PCT/SE2023/051272

§ 371 Date: Jun. 20, 2025

(30) Foreign Application Priority Data
Dec. 21, 2022 (SE) 2251532-4

(51) Int. Cl. C08G 71/04

(52) U.S. Cl. CPC C08G 71/04

(57) ABSTRACT

The invention pertains to a process for preparing a random co-poly(urethane-carbonate) comprising reacting a 6-membered di-cyclic carbonate with a polyamine via a ring-opening polymerization (ROP) by catalytic control for carbonate unit formation, in the presence of a catalyst, through a ring-opening polymerization reaction. Also, the invention pertains to a random co-poly(urethane-carbonate) being obtainable by said process.

### FIELD OF THE INVENTION

The invention belongs to the technical field of polymer synthesis, in particular to the field of manufacture of Isocyanate-free and BPA-free copolymers via ring-opening polymerization and the resulting co-polymers.

### BACKGROUND OF THE INVENTION

Polyurethanes are widely used in foams, seals, high performance coatings and adhesives. The polymers are also expected to find increasing use in biomedical field due to their features of biodegradability and biocompatibility.

Despite of the functionally desirable features, the main drawback with these polymers is that the processes for their manufacture involve highly toxic reagents, primarily phosgene and isocyanates. There is currently a growing demand for polyurethanes and copolymers produced without the use of phosgene and isocyanate.

It is known that cyclic carbonates have attracted attention in recent years as potential monomers for the production of polyurethanes, polycarbonates and copolymers through phosgene- and isocyanate-free route [1].

Polycarbonates have been used for a wide range of applications from automotive parts to electronic appliances, and are obtained from aromatic or aliphatic dioxy compounds by means of a carbonate. The main polycarbonate material is obtained from polymerization of 2,2-bis(4-hydroxyphenyl) propane (bisphenol A) with toxic phosgene or diphenylcarbonate, which is derived from reaction of phenol with phosgene, and the product requires high purity without the presence of chlorinated impurities. However, the main raw material, BPA shows estrogenic properties, and the release of BPA from polycarbonates has been studied on exposure and risk assessments in a large number of studies, because of the widespread use of polycarbonates in food and drink packaging, such as food cans, bottle caps, water supply pipes, and dental sealants and tooth coatings.

Attempts have been made to develop routes to make Isocyanate-free PU and BPA-free PC, and one way of getting around these toxic raw materials is to produce the polymers by ring-opening polymerization (ROP) of cyclic carbonates [1,2,3].

Methods starting from five-membered alkylene carbonates as cyclic carbonates are one option, however, due to thermodynamic properties, the ROP of five-membered cyclic carbonates is a slow reaction that has been reported to proceed in the presence of catalysts such as metal alkoxides, metal acetylacetonates, and metal alkyls. The ROP reaction rate of the six-membered cyclic carbonates are higher, however, such monomers are generally not commercially available and their production has not been straightforward.

Thus, there is a need for the development of novel manufacturing methods for producing isocyanate-free and BPA-free polycarbonates.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a process for preparing a random co-poly(urethane-carbonate) comprising reacting a 6-membered di-cyclic carbonate with a polyamine via a ring-opening polymerization (ROP) by catalytic control for carbonate unit formation, in the presence of a catalyst, through a ring-opening polymerization reaction, by heating up a mixture of a 6-membered di-cyclic carbonate according to formula I, a polyamine and a catalyst, to obtain a random co-poly(urethane-carbonate)

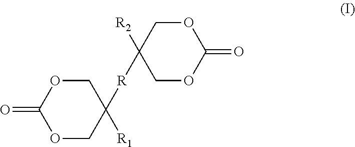

wherein;
R is selected from the group consisting of C1-C20 carbonate, oxygen (ether), C1-C20 di-alkyl, C1-C20 alkylether, C1-C20 ketone, C1-C20 ester;
R₁ and R₂, are independently of each other, selected from the group consisting of H, C1-C20 alkyl, hydroxyl, C1-C20 hydroxyalkyl, phenyl, C6-C20 phenylalkyl, C3-C20 alkylcarbonyl, C3-C20 carbonylalkyl, C4-C20 alkoxycarbonyl, C4-C20 alkoxycarbonyloxy, C2-C20 carboxyl group or their derivatives.

Also provided is a process, wherein the 6-membered di-cyclic carbonate is a di-cyclic carbonate according to formula II;

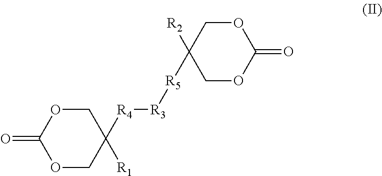

R₃ is selected from the group consisting of oxygen, C(O), OC(O), C(O)O, and OC(O)O;
R₄ and R₅, are independently of each other C1-C20 alkylene;
R₁ and R₂, are independently of each other, selected from the group consisting of H, C1-C20 alkyl, hydroxyl, C1-C20 hydroxyalkyl, phenyl, C6-C20 phenylalkyl, C3-C20 alkylcarbonyl, C3-C20 carbonylalkyl, C4-C20 alkoxycarbonyl, C4-C20 alkoxycarbonyloxy, C2-C20 carboxyl group or their derivatives.

Further is provided a process, wherein the molar ratio of polyamine to 6-membered di-cyclic carbonate is from 0.01:1 to 1:0.01, or from 0.1:1 to 1:0.1, or from 0.01:1, or 0.1:1, or 0.2:1 to 1:2, or from 1:0.01, or 1:0.1, or 1:0.2 to 2:1, such as from 0.25:1 to 1:0.25 or even more preferably from 0.25:1 to 1:2 or 0.3:1 to 0.9:1.

Also is provided a process, wherein the 6-membered di-cyclic carbonate is di-trimethylolpropane di-cyclic carbonate (DTMP-DC), or pentaerythritol dicarbonate (PE-DC); preferably the 6-membered di-cyclic carbonate being di-trimethylolpropane di-cyclic carbonate (DTMP-DC).

Further, a process wherein the polyamine is selected from the group consisting of alkyldiamines, such as from 1,6-hexamethylenediamine, 1,2-diethylenediamine and isophorone diamine, bio-based diamines, such as amine derivatives of dimerized fatty acids, and polymeric di-, tri-, and poly-amines, such as block copolymers with a polyether frame consisting of polyethylene glycol and polypropylene glycol with terminal amino functional groups.

Further is provided a random co-poly(urethane-carbonate), said random co-poly(urethane-carbonate) being obtainable by the process.

Further, for the random co-poly(urethane-carbonate), an FT-IR spectra of the random co-poly(urethane-carbonate) shows a hydroxyl peak at about 3200 cm⁻¹, such as between 3000 to 3400 cm⁻¹.

Further, an article comprising the random co-poly(urethane-carbonate), wherein the article has been produced by blow moulding, injection moulding or sheet extrusion.

Also, a film, fibre or a pipe comprising a random co-poly(urethane-carbonate).

Further, the use of a random co-poly(urethane-carbonate) for the production of a film, an article by blow moulding or injection moulding, a fibre or a pipe.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 shows an example of a reaction overview for (A) the random polymerization process of the invention to produce isocyanate-free and BPA-free co-poly(urethane-carbonate) from six-membered dicyclic carbonates with polyamine at a certain molar ratios. (B) shows a comparison example to produce polyurethane without carbonate unit in the polymer;

FIG. 2 shows a formula for an example of a isocyanate-free and BPA-free co-poly(urethane-carbonate) of the invention;

FIG. 3 shows a table summarizing examples and comparisons on the polymerization of Di-trimethylolpropane di-cyclic carbonate (DTMP-DC) with polyamine (Jeffamine® ED-600) at different ratios (Modifier: 1,4-butanediol, Cat.: 1,8-Diazabicyclo[5.4.0]undec-7-ene (DBU);

FIG. 4 shows Shore D hardness of polyurethane (comparison 1), polycarbonate (comparison 2), and isocyanate-free and BPA-free co-poly(urethane-carbonate) (example 1-7), Comparison 1, and Example 1 and 7 indicate below 1 (Shore D hardness);

FIG. 5 shows a FTIR spectra of (A) DTMP-DC, (B) Polyamine (Jeffamine® ED-600), (C) Polyurethane (comparison 1), (D) Polycarbonate (comparison 2);

FIG. 6 shows an FTIR spectra of (A) isocyanate-free and BPA-free co-poly(urethane-carbonate) (example 1), (B) isocyanate-free and BPA-free co-poly(urethane-carbonate) (example 2), (C) isocyanate-free and BPA-free co-poly(urethane-carbonate) (example 3), and (D) isocyanate-free and BPA-free co-poly(urethane-carbonate) (example 4);

FIG. 7 shows an FTIR spectra of (A) isocyanate-free and BPA-free co-poly(urethane-carbonate) with 1 g modifier (example 5), (B) isocyanate-free and BPA-free co-poly(urethane-carbonate) 2 g modifier (example 6), and (C) isocyanate-free and BPA-free co-poly(urethane-carbonate) 3 g modifier (example 7);

FIG. 8 shows a picture of isocyanate-free and BPA-free co-poly(urethane-carbonate) prepared from DTMP-DC and diamine (Jeffamine® ED-600) at ratio of 30/5 in molder (example 6); and 5

FIG. 9 shows an example of a reaction for the production of isocyanate-free and BPA-free co-poly(urethane-carbonate) s from DTMP-DC and diamine (Jeffamine® ED-600) at ratio of urethane unit/carbonate unit of 30/20 randomly distributed.

### DESCRIPTION OF EMBODIMENTS

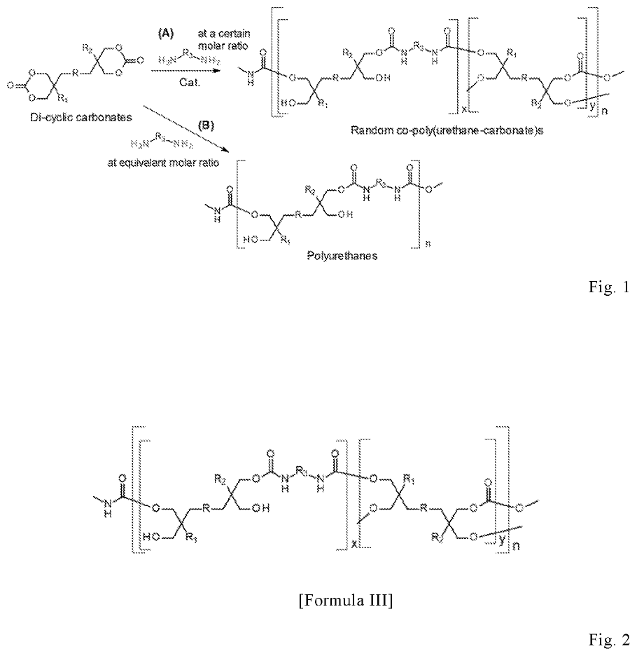

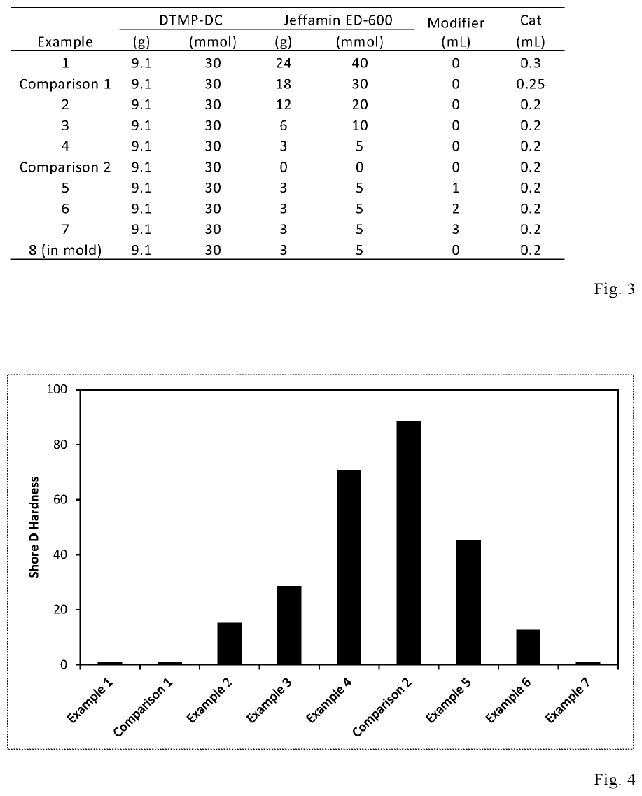

The following description focuses on an embodiment of the present invention applicable to a method of manufacturing manufacture isocyanate-free and BPA-free co-poly(urethane-carbonate) s via the ring-opening polymerization of di-cyclic carbonate with polyamine at different ratio controlled using base catalyst (FIG. 1A illustrates a non-limiting example of such a reaction). Furthermore, the resulting polymer containing both urethane and carbonate unit in the molecule, ordered as random structure (FIG. 2 illustrates a non-limiting example of such a structure).

Attempts have been made to develop routes to make Isocyanate-free PU and BPA-free PC, and one way of getting around these toxic raw materials is to produce the polymers by ring-opening polymerization (ROP) of cyclic carbonates [1,2,3]. Five-membered alkylene carbonates have been considered to a less extent for commercial use owing to thermodynamic properties in the ROP. The ROP of five-membered cyclic carbonates is a slow reaction that has been reported to proceed in the presence of catalysts such as metal alkoxides, metal acetylacetonates, and metal alkyls. The polymerization involves partial decarboxylation and the loss of CO2 such that the polymer produced contains both carbonate and ether linkages.

The reactivity of five- and six-membered cyclic carbonates substituted with allyl and homoallyl groups, 5-(2-propenyl)-1,3-dioxan-2-one and 4-(3-butenyl)-1,3-dioxolan-2-one with hexylamine and benzylamine was compared [4]. The reaction rate of the six-membered cyclic carbonate at 30-70° C. was 29 to 62 times larger than those of the five-membered one. Thus, six-membered cyclic carbonates seem to provide more opportunities to be used in the polymerization. Although six-membered cyclic carbonates are thermodynamically more suitable precursors, their production has not been straightforward and the monomers are not readily commercially available.

In the invention, it was found that di-cyclic carbonate can be used to manufacture isocyanate-free and BPA-free co-poly(urethane-carbonate) s via the ring-opening polymerization with polyamine at different ratio of di-cyclic carbonate and polyamine under catalytic control for urethane and carbonate formation (example illustrated in FIG. 1A). This is a mild environment-friendly process without using phosgene, other chlorinated materials, and bisphenol.

Cyclic carbonates were reacted with amine or diamine compounds in the absence or presence of catalyst. Mono-cyclic carbonate can be ring-opened to form urethane bond with amine compound, but may not be polymerized, while it can be polymerized to PC by catalyst. Meanwhile, di-cyclic carbonate can form both PU with polyamine and PC by catalyst. Thus, di-cyclic carbonate reacts with polyamine at different ratios with or without heating by using base catalyst.

Here, the ratio of 1/1 (equivalent molar ratio, di-cyclic carbonate/polyamine) produces only PU theoretically, while the ratio of I/O (without polyamine) produces only PU theoretically. Therefore, in the invention, a ratio of polyamine to di-cyclic carbonate is used to control the ratio of PU- and PC unites in the co-poly(urethane-carbonate) s.

As a the random co-poly(urethane-carbonate) may comprise a free hydroxyl group, a FT-IR spectra of the random co-poly(urethane-carbonate) may show a hydroxyl peak at about 3200 cm⁻¹, such as between 3000 to 3400 cm⁻¹.

It was found that the random co-polymers resulting from the reaction using both di-cyclic carbonate and polyamine were novel materials having unique properties and structures, and that the ratio of PU- and PC unites in the production process can be used to control their properties.

In order to achieve the above objective, the preparation method of the degradable a random co-poly(urethane-carbonate). The process comprises polymerisation of a 6-membered di-cyclic carbonate with a polyamine via a ring-opening polymerization (ROP) by catalytic control for carbonate unit formation, in the presence of a catalyst. The process may be a multistage process. The process may comprise the steps of: providing a 6-membered di-cyclic carbonate, adding a polyamine and a catalyst, and heating the resulting mixture to obtain the random co-poly(urethane-carbonate) through a polymerization reaction.

More specifically, the comprises heating up a mixture of a 6-membered di-cyclic carbonate according to formula I a polyamine and a catalyst, to obtain a random co-poly(urethane-carbonate).

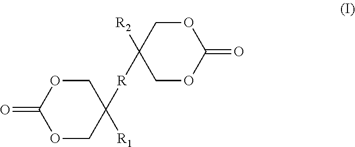

Here, R is selected from the group consisting of C1-C20 carbonate, oxygen (ether), C1-C20 di-alkyl, C1-C20 alkylether, C1-C20 ketone, C1-C20 ester;

R₁ and R₂, are independently of each other, selected from the group consisting of a direct bond, H, C1-C20 alkyl, hydroxyl, C1-C20 hydroxyalkyl, phenyl, C6-C20 phenylalkyl, C3-C20 alkylcarbonyl, C3-C20 carbonylalkyl, C4-C20 alkoxycarbonyl, C4-C20 alkoxycarbonyloxy, C2-C20 carboxyl group or their derivatives.

The 6-membered di-cyclic carbonate may also be a di-cyclic carbonate according to formula II;

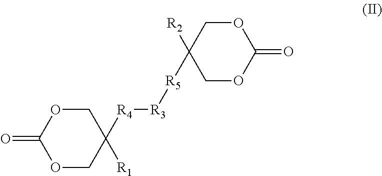

Here, R₃ is selected from the group consisting of a direct bond, oxygen, C(O), OC(O), C(O)O, and OC(O)O;
R₄ and R₅, are independently of each other C1-C20 alkylene;
R₁ and R₂, are independently of each other, selected from the group consisting of none, H, C1-C20 alkyl, hydroxyl, C1-C20 hydroxyalkyl, phenyl, C6-C20 phenylalkyl, C3-C20 alkylcarbonyl, C3-C20 carbonylalkyl, C4-C20 alkoxycarbonyl, C4-C20 alkoxycarbonyloxy, C2-C20 carboxyl group or their derivatives.

In the process, the six-membered di-cyclic carbonate may be di-trimethylolpropane di-cyclic carbonate (DTMP-DC), pentaerythritol dicarbonate (PE-DC) or combinations thereof. DTMO and PE are both well-known commercial products making the invention readily available for use.

In the process, a mixture of more than one type of 6-membered di-cyclic carbonate may be used.

The polymines of the process may be alkyldiamines, such as 1,6-hexamethylenediamine, 1,2-diethylenediamine and isophorone diamine, bio-based diamines, such as amine derivatives of dimerized fatty acids (dimer diamine), and polymeric di-, tri-, and poly-amines, such as block copolymers with a polyether frame consisting of polyethylene glycol and polypropylene glycol with terminal amino functional groups.

The polyamine may be a block copolymer with a polyether frame consisting of polyethylene glycol and polypropylene glycol with terminal amino functional groups. Such polymaines are also well-known commercial products, such as Priamine® and Jeffamine®, making the method of the invention readily available to implement and use. In one example of the invention, the bio-based diamine is Priamine®.

In the process, a mixture of more than one type of polyamine may be used.

For the reaction to result in a random co-polymer, the molar ratio of polyamine to used di-cyclic carbonate is not limited, but is preferably from 0.01:1 to 1:0.01, or from 0.1:1 to 1:0.1, or from 0.01:1, or 0.1:1, or 0.2:1 to 1:2, or from 1:0.01, or 1:0.1, or 1:0.2 to 2:1, such as from 0.25:1 to 1:0.25 or even more preferably from 0.25:1 to 1:2 or 0.3:1 to 0.9:1.

The polyamine to used di-cyclic carbonate may be at a non-equivalent molar ratio. This to promote formation of a random copolymer.

The ratio of polyamine to di-cyclic carbonate may be expressed as a molar ratio of from 0.01-0.99:1 to 1:0.99-0.01, such as from 0.1-0.9:1 to 1:0.1-0.9, such as from 0.2-0.8:1 to 1:0.8-0.2, or from 0.3-0.8:1 to 1:0.8-0.3 (mol:mol).

It was found that a polycarbonate produced using ROP of DTMP-DC without polyamine (see Comparison 2) obtains a high shore D hardness of >90, while the Polyurethane produced The using opening polymerization of DTMP-DC and diamine (Jeffamine® ED-600) at equivalent molar ratios obtains a Shore D hardness of <1.

By decreasing the ratio of polyamine used, it was found that the Shore D hardness was increased from <1 (Example 1) to 15.2 (Example 2), to 28.6 (Example 3), to 70.8 (Example 4), and to 88.4 (Comparison 2, no use of polyamine).

The preferred weight ratio of polyamine to used di-cyclic carbonate is between 0.1:1 to 1:0.1. Using the method of the invention, this results in a strong and resilient co-polymer material.

Mixture of di-cyclic carbonates, mixture of di-cyclic carbonate with mono-cyclic carbonate, and mixture of polymines can be used for the polymerization, respectively. In one example of the invention, di-cyclic carbonates are used in the method of the invention. In one further example, a mixture of di-cyclic carbonate with mono-cyclic carbonate is used.

The polymerization temperature is selected according to different monomers and initiators and required requirements. The polymerization temperature may be 0° C. or higher, such as 30° C. or higher, 60° C. or higher, such as 100° C. or higher, 140° C. or higher, or 180° C. or higher.

By having a polymerization temperature of at least 80° C., such as 80 to 180° C., the resulting material will be strong and elastic, as shown by the compound properties of the co-polymers of examples 1 to 8, where the polymerization temperature was 95 degrees.

In one example, the polymerization temperature of at least 80° C., such as 80 to 180° C.

The polymerization reaction time of is from 1 minute to 24 hours, such as from 20 minutes to 3 hours, such as from 30 minutes to 2 hours, such as 1 hour. In Examples 1-8, the duration of polymerization reaction time was 1 hour.

Preferably, the preparation method includes a melting step, wherein the 6-membered di-cyclic carbonate is melted before the addition of the adding a polyamine and a catalyst.

Alternatively, the melting step takes place after the addition of the polyamine and/or catalyst.

The melting temperature is selected primarily according to the melting point of the 6-membered di-cyclic carbonate. The melting temperature of the melting step could be 0° C. or higher, such as 30° C. or higher, such as 60° C. or higher, such as 100° C. or higher, 140° C. or higher, or 180° C. or higher.

Preferably, the melting temperature is at least the melting point of the 6-membered di-cyclic carbonate.

In examples 1 to 8, the melting temperature was 105° C. for the co-carbonate DTMP-DC. The melting temperature may also be slightly higher than the melting point of the 6-membered di-cyclic carbonate, such as 5, 10, 15, 20 or 50 degrees higher than the melting point of the 6-membered di-cyclic carbonate.

The duration of the melting step may be from 0 to 60 minutes, depending on the amount of material, but preferably 1 to 30 minutes, such as 5 minutes. In Examples 1-8, the melting step was 5 minutes.

One advantage of melting the 6-membered di-cyclic carbonate is that the often solid form 6-membered di-cyclic carbonate will mix much more efficient with the polyamine and a catalyst (which are often in liquid form) when melted. This is especially beneficial when the reaction takes place in a solution-free environment. Having the reaction take place in a solution-free environment makes it a mild environment-friendly process.

Thus, the method may be solvent-free.

The reaction and application may be performed in solution form and any organic solvent may be used, although not necessary for the reaction. However, preferred solvents are alcohols (e.g. methanol, ethanol and propanol), (cyclic) ethers (e.g. diethyl ether and THF), ketones (e.g. acetone, ethylmethylketone), toluene, acetonitrile, halogenated alkane (dichloromethane and chloroform), dimethylformamide, and pyridine or mixtures of the same or mixtures containing said solvents. Use of solvent may provide benefits for homogenization, polymerization and application.

The catalyst is a heterogeneous or homogeneous catalyst.

The catalyst may be a inorganic, organometallic catalyst or organocatalyst.

An inorganic and organometallic catalysis can be selected from various proficient systems based on metal centers, such as sodium, potassium, zinc, magnesium, calcium, tin, titanium, caesium or rare-earth metals, bearing suitable ancillary ligands.

Metal-based catalysts have high catalytic efficiency but can lead to metal pollution in the product, which may impact on the application of the polymer in the field of biomedicine. Therefore, it may be beneficial to use organic catalysts.

Organocatalysts can be used to lead ROP of dicyclic carbonates, and include commercially available amine (such as 4-N,N-dimethylaminopyridine), guanidines (such as 1,5,7-triazabicyclo-[4.4.0]dec-5-ene, phosphazene (such as 2-tert-butylimino-2-diethylamino-1,3-dimethylperhydro-1,3,2-diazaphosphorine), amidine (such as 1,8-Diazabicycloundec-7-ene), tertiary amines (such as dimethylethanolamine), N-heterocyclic carbenes, and bifunctional thiourea-tertiary amine catalysts.

In examples 1-8, the catalyst is 1,8-Diazabicyclo[5.4.0]undec-7-ene (DBU). In one example, the Organocatalyst is an amidine catalyst. In one further example, the Organocatalyst is 1,8-Diazabicyclo[5.4.0]undec-7-ene (DBU).

The weight ratio of catalyst to used di-cyclic carbonate is not limited. Preferably, the weight ratio of catalyst to used di-cyclic carbonate is 0.000001:1 to 1:1, such as from 0.000001:1, or 0.00001:1, such as from 0.0001:1, or 0.001:1, or 0.01:1, or 0.1:1 to 1:1, preferably from 0.0001 to 1:1 (wt:wt). It was found that when the amount of initiator is too small, the polymerization reaction would cross-link to form a gel in a short time, while a too large amount of inhibitor the crosslinking will be inhomogeneous.

Thus, in one preferred example, the weight ratio of catalyst to used di-cyclic carbonate is 0.001 to 10 wt %, such as 0.01 to 1 wt %.

The organocatalysts can be used in the presence of an alcohol. An alcohol such as benzyl alcohol, 1,3-propanediol, glycerol and 1-propanol that acts as a co-initiator, a chain-transfer and a modifier agent, can be used with catalysts. These agents can play roles to control property and to properly mix monomers in the process. The weight ratio of alcohols to used di-cyclic carbonate is not limited, but the ratio can preferably be used at a ratio of 0.01 to 100 wt % such as 0.01, 0.1, 1, 10 and 100 wt %, or even more preferred 0.1 to 30 wt %.

The process may also comprise the addition of a modifying agent (modifier).

The modifier can play roles to control property and to properly mix monomers in the process, thus it was found that the material properties, such as shore D hardness, of the co-polymer could be further modified with a modifier.

The modifying agent may be an alcohol such as benzyl alcohol, 1,3-propanediol, glycerol and/or 1-propanol. The modifying agent may also be 1,4-butanediol.

The weight ratio of modifier to used di-cyclic carbonate is not limited, but the ratio can preferably be used at a ratio of 0.0001:1 to 1:1 (wt:wt), such as from 0.0001:1, or 0.001:1, or 0.01:1, or 0.1:1 to 1:1, or preferably from 0.001:1 to 0.3:1 (wt:wt).

For instance, use of 1,4-butanediol can form ester unit in the polymer chain, or be in end group. In Examples 5-7, 1,4-butanediol was used as modifier. The Shore D hardness result showed that with increasing amount of modifier, the hardness was decreased as order as 70.8 (Example 4, 0 g modifier), 45.2 (Example 5, 1 mL modifier), 12.6 (Example 6, 2 mL modifier) and <1 (Example 7, 3 g modifier) (FIG. 4).

In one example of the invention, the molar ratio of polyamine to used di-cyclic carbonate is from 30 to 91 wt %, the 6-membered di-cyclic carbonate is di-trimethylolpropane di-cyclic carbonate (DTMP-DC), the polyamine is a block copolymer with a polyether frame consisting of polyethylene glycol and polypropylene glycol with terminal amino functional groups, and the catalyst may be the organocatalyst 1,8-Diazabicyclo[5.4.0]undec-7-ene (DBU), and the process also comprises addition of the modifying agent 1,4-butanediol.

The reaction was performed under normal pressure (1 atm), however, it may also be performed under higher or lower pressure, for instance a higher pressure may be used to allow for higher temperatures in the presence of solvents.

The polymerization can be performed by means of molding, casting, coating, brown film and extrusion.

Thus, in the invention, a random co-poly(urethane-carbonate) may be obtained using the process of the invention as described above.

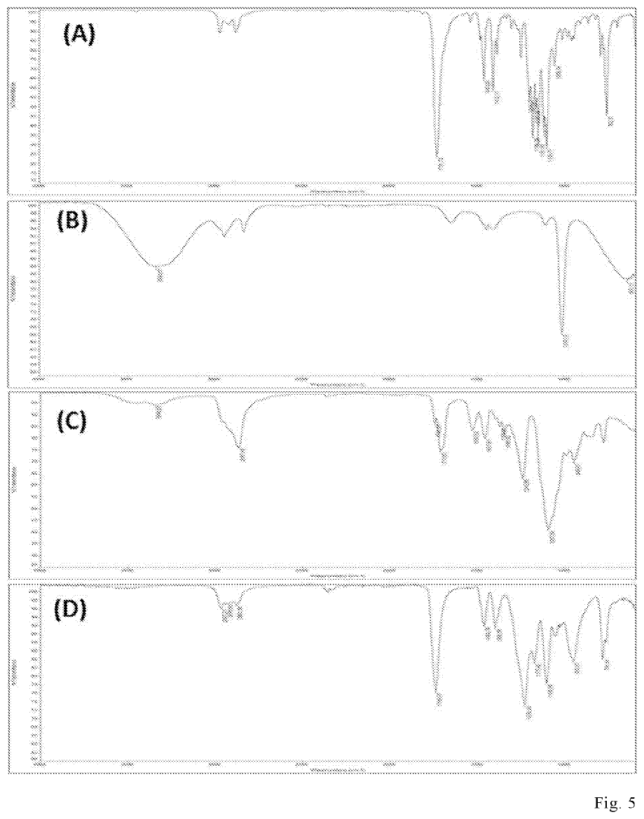

The structure of the random co-poly(urethane-carbonate) s in the Examples were confirmed by FT-IR spectras, as can be seen in FIGS. 5 to 7, showing inter alia the presence of a free hydroxyl group.

As seen, an FT-IR spectra of the random co-poly(urethane-carbonate) of the invention shows a hydroxyl peak at around 3200 cm⁻¹.

Being a random copolymer, the monomer residues are located randomly in the polymer molecule (instead of in linear arrangement of blocks, such in block co-polymers).

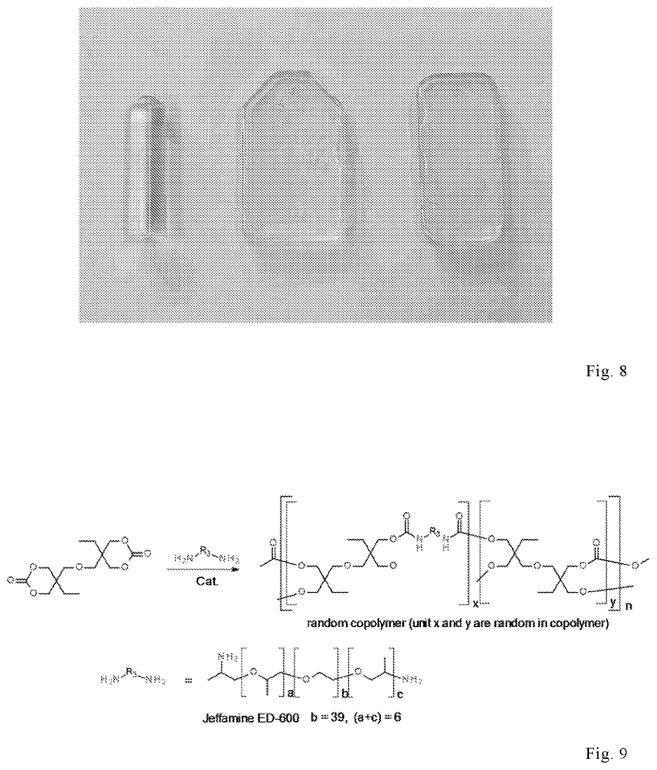

A resulting isocyanate-free and BPA-free co-poly(urethane-carbonate can be seen in FIG. 8, which depicts a co-poly(urethane-carbonate) prepared from DTMP-DC and diamine (Jeffamine® ED-600) at ratio of 30/5 in molder (according to example 6).

As can be seen in FIG. 4, the co-polymer of the invention obtains different properties from polycarbonate produced using ROP of DTMP-DC without polyamine (Comparison 2), or from Polyurethane produced the using ring opening polymerization of DTMP-DC and diamine (Jeffamine® ED-600) at equivalent molar ratios.

Shore D hardness of the co-polycarbonate produced using ROP of DTMP-DC without polyamine (Comparison 2) was close to 90 (88.4), while the Polyurethane produced the using ring opening polymerization of DTMP-DC and diamine (Jeffamine® ED-600) at equivalent molar ratios was <1.

For the co-polymers of the invention, the shore D hardness is in the range of >1 to 85, such as in the range from 1 to 80 or 5 to 75. It follows that a decreasing ratio of polyamine results in an increased Shore D hardness <1 (Example 1) to 15.2 (Example 2), to 28.6 (Example 3), to 70.8 (Example 4), and to 88.4 (Comparison 2, no use of polyamine).

For the examples using a modifier, the Shore D hardness could be decreased by increasing the amount of modifier. The Shore D hardness result showed that with increasing amount of modifier, the hardness was decreased as order as 70.8 (Example 4, 0 g modifier), 45.2 (Example 5, 1 mL modifier), 12.6 (Example 6, 2 mL modifier) and <1 (Example 7, 3 g modifier) (FIG. 4).

In one aspect of the invention, the shore D hardness is from is in the range of 1 to 85, such as in the range from 1 to 80.

Thus, the method of the invention will lead to a strong and resilient random co-polymer. The co-polymer being random, it is also easy to obtain a broad range of melting point and seal initiation temperature (SIT), and the random co-cpolymers will also achieve good radiation resistance.

Furthermore, the Glass Transition Temperature (Tg) will be >50° C.

Thus, the random co-poly(urethane-carbonate) is suitable for many applications, such as articles produced by blow moulding, injection moulding or sheet extrusion. Such articles may be a film, fibre or a pipe.

The invention thus also pertains to the use of a random co-poly(urethane-carbonate) according for the production of a film, of an article by blow moulding or injection moulding, of a fibre or of a pipe.

According to a specific but non-limiting embodiment of a resulting Isocyanate-free and BPA-free random co-poly(urethane-carbonate) was found to have the having the formula III:

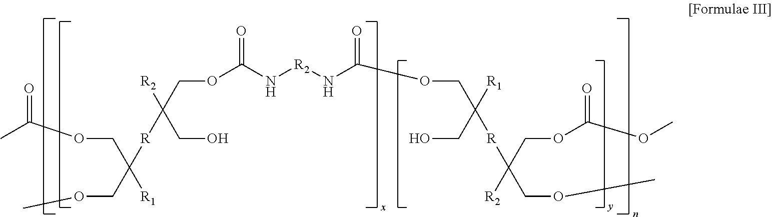

where
R is selected from the group consisting of oxygen (ether), C1-C20 alkylether, C1-C20 alkyl, C3-C20 ketone, C3-C20 ester, C1 to C20 carbonate;
R₁, R₂, and R₃ are independently selected from the group consisting of none, H, C1-C20 alkyl, hydroxyl, C1-C20 hydroxyalkyl, C6-C20 phenyl, C6-C20 phenylalkyl, C3-C20 alkylcarbonyl, C3-C20 carbonylalkyl, C4-C20 alkoxycarbonyl, C4-C20 alkoxycarbonyloxy, C2-C20 carboxyl group or their derivatives;
n is at least 1, and for each n, x is from 1 to 100000 and y is from 1 to 100000.

In the co-polymer, the ratio of x to y in the random co-poly(urethane-carbonate), is from 1:99 to 99:1, or 1:66 to 66:1, or 30:40 to 30:5 (mol/mol).

### Comparisons and Examples

The present invention is further explained in more detail with reference to the following examples. These examples, however, should not be interpreted as limiting the scope of the present invention.

The reaction and production were monitored by FT-IR analyses using Nicolet-iS5 (Thermo Scientific, USA). The Shore D hardness of the resulting materials was measured at room temperature by using a digital hardness durometer (BGD 935/D, Biuged Laboratory Instruments). The results were averaged from five tests conducted in several zones of the samples.

The number average molecular weight of the polymer in the following examples is determined by gel permeation chromatography (GPC) using tetrahydrofuran as a solvent and polystyrene of a known average molecular weight as a standard sample. GPC is a type of size-exclusion chromatography (SEC), that separates analytes on the basis of size, typically in organic solvents. The technique is often used for the analysis of polymers.

Comparison 1.—Production of isocyanate-free PU from DTMP-DC and diamine (Jeffamine® ED-600)

The ring opening polymerization of DTMP-DC with equivalent molar ratio of polyamine produces PU. 9.1 g 9.1 g (30 mmol) DTMP-DC was melt at 110° C. in 50 mL reaction vessel, followed by addition of 18 g (equivalent molar, 30 mmol) pre-heated Jeffamin ED-600, which is pre-mixed with 0.25 mL 1,8-Diazabicyclo[5.4.0]undec-7-ene (DBU, catalyst) at 110° C. After 5 minutes, the polymerization was continued and completed at 95° C. for 1 hour. The structure was confirmed by FT-IR (FIG. 5C), and Shore D hardness was measured as <1 (FIG. 4).

Comparison 2.—Production of BPA-free PC from DTMP-DC

The ring opening polymerization of DTMP-DC without polyamine produces PC. 9.1 g (30 mmol) DTMP-DC was melt at 110° C. in 50 mL reaction vessel, followed by addition of 1,8-Diazabicyclo[5.4.0]undec-7-ene (DBU, catalyst) at 110° C. After 5 minutes, the polymerization was continued and completed at 95° C. for 1 hour. The structure was confirmed by FT-IR (FIG. 5D), and Shore D hardness was measured as 88.4 (FIG. 4).

FIG. 5. FTIR spectra of (A) DTMP-DC, (B) Polyamine (Jeffamine® ED-600), (C) Polyurethane (comparison 1), (D) Polycarbonate (comparison 2)

Example 1.—Production of isocyanate-free and BPA-free co-poly(urethane-carbonate) s from DTMP-DC and diamine (Jeffamine® ED-600) at ratio of 30/40 (Table 1)

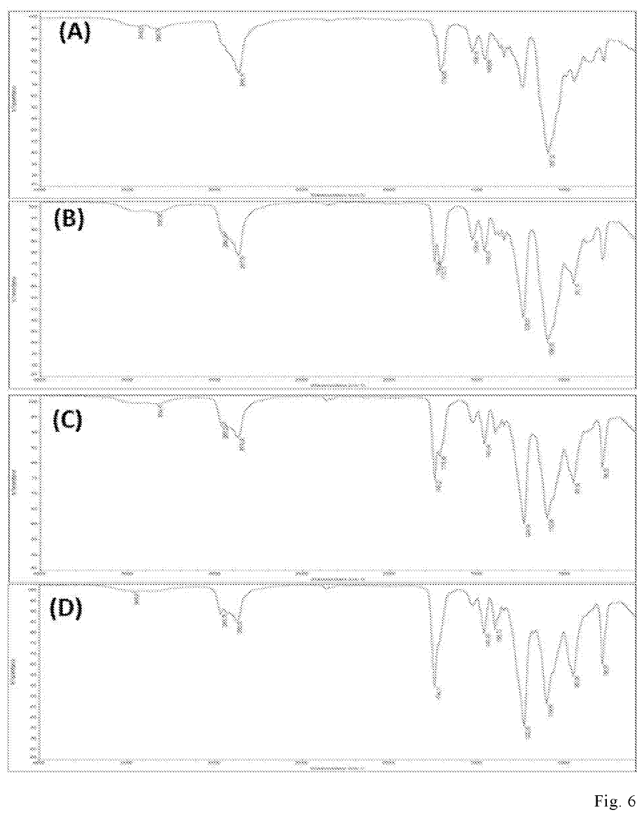

Use of excess molar ratio of polyamine to DTMP-DC can produce shorter chain of isocyanate-free and BPA-free co-poly(urethane-carbonate) s by catalysis since carbonate group is not sufficient to react with amine terminal group. However, in the same time, some of carbonate unit can be formed by catalyst. 9.1 g (30 mmol) DTMP-DC was melt at 110° C. in 50 mL reaction vessel, followed by addition of 24 g (40 mmol) pre-heated Jeffamin ED-600 mixed with 0.3 mL 1,8-Diazabicyclo[5.4.0]undec-7-ene (DBU, catalyst) at 110° C. After 5 minutes, the polymerization was continued and completed at 95° C. for 1 hour. The structure was confirmed by FT-IR (FIG. 6A), and Shore D hardness was measured as <1 (FIG. 4).

Example 2.—Production of isocyanate-free and BPA-free co-poly(urethane-carbonate) s from DTMP-DC and diamine (Jeffamine® ED-600) at ratio of urethane unit/carbonate unit of 30/20 randomly distributed (Table 1 and FIG. 9)

Use of less molar ratio of polyamine to DTMP-DC can produce isocyanate-free and BPA-free co-poly(urethane-carbonate) s by catalysis. Amine group react with cyclic carbonate group, which is also polymerized to form carbonate by catalyst. 9.1 g (30 mmol) DTMP-DC was melt at 110° C. in 50 mL reaction vessel, followed by addition of 12 g (20 mmol) pre-heated Jeffamin ED-600 mixed with 0.2 mL 1,8-Diazabicyclo[5.4.0]undec-7-ene (DBU, catalyst) at 110° C. After 5 minutes, the polymerization was continued and completed at 95° C. for 1 hour. The structure was confirmed by FT-IR (FIG. 6B), and Shore D hardness was measured as 15.2 (FIG. 4).

Example 3.—Production of isocyanate-free and BPA-free co-poly(urethane-carbonate) s from DTMP-DC and diamine (Jeffamine® ED-600) at ratio of 30/10 (Table 1)

Use of less molar ratio of polyamine to DTMP-DC can produce isocyanate-free and BPA-free co-poly(urethane-carbonate) s by catalysis. Amine group react with cyclic carbonate group, which is also polymerized to form carbonate by catalyst. 9.1 g (30 mmol) DTMP-DC was melt at 110° C. in 50 mL reaction vessel, followed by addition of 6 g (10 mmol) pre-heated Jeffamin ED-600 mixed with 0.2 mL 1,8-Diazabicyclo[5.4.0]undec-7-ene (DBU, catalyst) at 110° C. After 5 minutes, the polymerization was continued and completed at 95° C. for 1 hour. The structure was confirmed by FT-IR (FIG. 6C), and Shore D hardness was measured as 28.6 (FIG. 4)

Example 4.—Production of isocyanate-free and BPA-free co-poly(urethane-carbonate) s from DTMP-DC and diamine (Jeffamine® ED-600) at ratio of 30/5 (Table 1)

Use of less molar ratio of polyamine to DTMP-DC can produce isocyanate-free and BPA-free co-poly(urethane-carbonate) s by catalysis. Amine group react with cyclic carbonate group, which is also polymerized to form carbonate by catalyst. With decreasing the polyamine ratio used, carbonate unit may be increased in the polymer chain. 9.1 g (30 mmol) DTMP-DC was melt at 110° C. in 50 mL reaction vessel, followed by addition of 3 g (5 mmol) pre-heated Jeffamin ED-600 mixed with 0.2 mL 1,8-Diazabicyclo[5.4.0]undec-7-ene (DBU, catalyst) at 110° C. After 5 minutes, the polymerization was continued and completed at 95° C. for 1 hour. The structure was confirmed by FT-IR (FIG. 6D), and Shore D hardness was measured as 70.8 (FIG. 4). With decreasing ratio of polyamine used, the Shore D hardness was increased from <1 (Example 1) to 15.2 (Example 2), to 28.6 (Example 3), to 70.8 (Example 4), and to 88.4 (Comparison 2, no use of polyamine).

FIG. 6. FTIR spectra of (A) isocyanate-free and BPA-free co-poly(urethane-carbonate) (example 1), (B) isocyanate-free and BPA-free co-poly(urethane-carbonate) (example 2), (C) isocyanate-free and BPA-free co-poly(urethane-carbonate) (example 3), and (D) isocyanate-free and BPA-free co-poly(urethane-carbonate) (example 4).

Example 5-7—Production of isocyanate-free and BPA-free co-poly(urethane-carbonate) s from DTMP-DC and diamine (Jeffamine® ED-600) at ratio of 30/5 with a modifier (1 g, 2 g, 3 g 1,4-butandiol, respectively) (Table 1)

Moreover, the polymer can be further modified with a modifier. The modifier can play roles to control property and to properly mix monomers in the process. For instance, use of 1,4-butanediol can form ester unit in the polymer chain, or be in end group. From above example 4, 9.1 g (30 mmol) DTMP-DC was melt at 110° C. in 50 mL reaction vessel, followed by addition of 1 g 1,4-butanediol and 3 g (5 mmol) pre-heated Jeffamin ED-600 mixed with 0.2 mL 1,8-Diazabicyclo[5.4.0]undec-7-ene (DBU, catalyst) at 110° C. After 5 minutes, the polymerization was continued and completed at 95° C. for 1 hour. The process was performed using 2 g and 3 g of 1,4-butanediol as well, respectively. The structure was confirmed by FT-IR (FIG. 5). In addition, Shore D hardness result showed that with increasing amount of modifier, the hardness was decreased as order as 70.8 (Example 4, 0 g modifier), 45.2 (Example 5, 1 mL modifier), 12.6 (Example 6, 2 mL modifier) and <1 (Example 7, 3 g modifier) (FIG. 4).

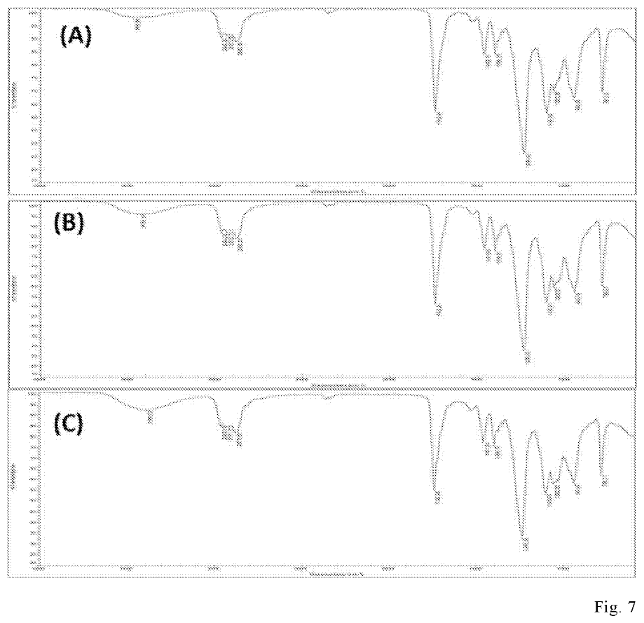

FIG. 7. FTIR spectra of (A) isocyanate-free and BPA-free co-poly(urethane-carbonate) with 1 g modifier (example 5), (B) isocyanate-free and BPA-free co-poly(urethane-carbonate) 2 g modifier (example 6), and (C) isocyanate-free and BPA-free co-poly(urethane-carbonate) 3 g modifier (example 7).

Example 8.—In situ molding and production of isocyanate-free and BPA-free co-poly(urethane-carbonate) s from DTMP-DC and diamine (Jeffamine® ED-600) at ratio of 30/5 (Table 1)

For example 4, the polymerization can be performed in molder. 9.1 g (30 mmol) DTMP-DC was melt at 110° C. in 50 mL reaction vessel, followed by addition of 3 g (5 mmol) pre-heated Jeffamin ED-600 mixed with 0.2 mL 1,8-Diazabicyclo[5.4.0]undec-7-ene (DBU, catalyst) at 110° C. After 5 minutes, the polymerization was continued and completed in a molder at 95° C. for 1 hour (FIG. 8).

FIG. 8. Picture of isocyanate-free and BPA-free co-poly(urethane-carbonate) prepared from DTMP-DC and diamine (Jeffamine® ED-600) at ratio of 30/5 in molder (example 6)

Although the present invention has been described above with reference to (a) specific embodiment(s), it is not intended to be limited to the specific form set forth herein. Rather, the invention is limited only by the accompanying claims and, other embodiments than the specific above are equally possible within the scope of these appended claims, e.g. different than those described above.

In the claims, the term “comprises/comprising” does not exclude the presence of other elements or steps. Furthermore, although individually listed, a plurality of means, elements or method steps may be implemented. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

### REFERENCES

[1] Pyo, S. H., Persson, P., Mollaahmad, M. A., Sörensen, K., Lundmark, S. and Hatti-Kaul, R., 2011. Cyclic carbonates as monomers for phosgene- and isocyanate-free polyurethanes and polycarbonates. Pure and Applied Chemistry, 84 (3), pp. 637-661.
[2] Wang, P., Park, J. H., Sayed, M., Chang, T. S., Moran, A., Chen, S. and Pyo, S. H., 2018. Sustainable synthesis and characterization of a bisphenol A-free polycarbonate from a six-membered dicyclic carbonate. Polymer chemistry, 9 (27), pp. 3798-3807.
[3] Carré, C., Ecochard, Y., Caillol, S. and Avérous, L., 2019. From the synthesis of biobased cyclic carbonate to polyhydroxyurethanes: A promising route towards renewable NonIsocyanate Polyurethanes. ChemSusChem, 12 (15), pp. 3410-3430.
[4] Tomita H., Sanda F., Endo T., Reactivity comparison of five- and six-membered cyclic carbonates with amines: Basic evaluation for synthesis of poly(hydroxyurethane), J. Polym. Sci. Part A: Polym. Chem. 2001:39:162-168.

1. A process for preparing a random co-poly(urethane-carbonate) comprising reacting a 6-membered di-cyclic carbonate with a polyamine via a ring-opening polymerization (ROP) by catalytic control for carbonate unit formation, in the presence of a catalyst, through a ring-opening polymerization reaction, by heating up a mixture of a 6-membered di-cyclic carbonate according to formula I a polyamine and a catalyst, to obtain a random co-poly(urethane-carbonate) 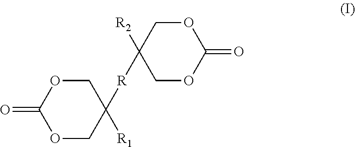
wherein;
R is selected from the group consisting of C1-C20 carbonate, oxygen (ether), C1-C20 di-alkyl, C1-C20 alkylether, C1-C20 ketone, C1-C20 ester;
R₁ and R₂, are independently of each other, selected from the group consisting of H, C1-C20 alkyl, hydroxyl, C1-C20 hydroxyalkyl, phenyl, C6-C20 phenylalkyl, C3-C20 alkylcarbonyl, C3-C20 carbonylalkyl, C4-C20 alkoxycarbonyl, C4-C20 alkoxycarbonyloxy, C2-C20 carboxyl group or their derivatives.

2. The process according to claim 1, wherein the 6-membered di-cyclic carbonate is a di-cyclic carbonate according to formula II; 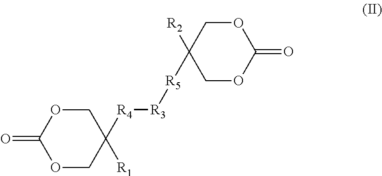
R₃ is selected from the group consisting of oxygen, C(O), OC(O), C(O)O, and OC(O)O;
R₄ and R₅, are independently of each other C1-C20 alkylene;
R₁ and R₂, are independently of each other, selected from the group consisting of H, C1-C20 alkyl, hydroxyl, C1-C20 hydroxyalkyl, phenyl, C6-C20 phenylalkyl, C3-C20 alkylcarbonyl, C3-C20 carbonylalkyl, C4-C20 alkoxycarbonyl, C4-C20 alkoxycarbonyloxy, C2-C20 carboxyl group or their derivatives.

3. The process according to claim 1, wherein the molar ratio of polyamine to 6-membered di-cyclic carbonate is from 0.01:1 to 1:0.01, or from 0.1:1 to 1:0.1, or from 0.01:1, or 0.1:1, or 0.2:1 to 1:2, or from 1:0.01, or 1:0.1, or 1:0.2 to 2:1, such as from 0.25:1 to 1:0.25 or even more preferably from 0.25:1 to 1:2 or 0.3:1 to 0.9:1.

4. The process according to claim 1, wherein the weight ratio of catalyst to 6-membered di-cyclic carbonate is from 0.000001:1 to 1:1, such as from 0.000001:1, or 0.00001:1, such as from 0.0001:1, or 0.001:1, or 0.01:1, or 0.1:1 to 1:1, preferably from 0.0001 to 1:1 (wt:wt).

5. The process according to claim 1, wherein the 6-membered di-cyclic carbonate is di-trimethylolpropane di-cyclic carbonate (DTMP-DC), or pentaerythritol dicarbonate (PE-DC); preferably the 6-membered di-cyclic carbonate being di-trimethylolpropane di-cyclic carbonate (DTMP-DC).

6. The process according to claim 1, wherein a mixture of more than one type of 6-membered di-cyclic carbonate is used.

7. The process according to claim 1, wherein the polyamine is selected from the group consisting of alkyldiamines, such as from 1,6-hexamethylenediamine, 1,2-diethylenediamine and isophorone diamine, bio-based diamines, such as amine derivatives of dimerized fatty acids, and polymeric di-, tri-, and poly-amines, such as block copolymers with a polyether frame consisting of polyethylene glycol and polypropylene glycol with terminal amino functional groups.

8. (canceled)

9. A process according to claim 1, wherein a mixture of more than one type of polyamine is used.

10. The process according to claim 1, wherein the catalyst is an inorganic, organometallic catalyst or organocatalyst.

11. The process according to claim 1, wherein
the inorganic and organometallic catalysis are be selected the group containing proficient systems based on metal centers, such as sodium, potassium, zinc, magnesium, calcium, tin, titanium, caesium or rare-earth metals, bearing suitable ancillary ligands, and/or
the organocatalysts are selected from the group consisting of amine (4-N,N-dimethylaminopyridine), guanidines (1,5,7-triazabicyclo-[4.4.0]dec-5-ene, phosphazene [2-tert-butylimino-2-diethylamino-1,3-dimethylperhydro-1,3,2-diazaphosphorine), amidine (1,8-Diazabicycloundec-7-ene), tertiary amines (dimethylethanolamine), N-heterocyclic carbenes, and bifunctional thiourea-tertiary amine catalysts, and/or wherein the catalyst is the organocatalyst 1,8-Diazabicyclo[5.4.0]undec-7-ene (DBU).

12. (canceled)

13. The process according to claim 1, wherein the polymerization temperature is 30° C. or higher, 60° C. or higher, 100° C. or higher, 140° C. or higher, or 180° C. or higher, and/or wherein the polymerization reaction time is from 1 minute to 24 hours, such as from 20 minutes to 3 hours, such as from 30 minutes to 2 hours.

14. (canceled)

15. The process according to claim 1, wherein the process also comprises addition of a modifying agent.

16. The process according to claim 15, wherein the weight ratio of modifying agent to di-cyclic carbonate is in a ratio of from 0.0001:1 to 1:1 (wt:wt), such as from 0.0001:1, or 0.001:1, or 0.01:1, or 0.1:1 to 1:1, or preferably from 0.001:1 to 0.3:1 (wt:wt).

17. The process according to claim 15, wherein the modifying agent is an alcohol such as benzyl alcohol, 1,3-propanediol, glycerol and/or 1-propanol, and/or the modifying agent is 1,4-butanediol.

18. (canceled)

19. The process according to claim 1, wherein
the molar ratio of polyamine to used di-cyclic carbonate is from 0.3:1 to 0.9:1
the 6-membered di-cyclic carbonate is di-trimethylolpropane di-cyclic carbonate (DTMP-DC),
the polyamine is a block copolymer with a polyether frame consisting of polyethylene glycol and polypropylene glycol with terminal amino functional groups, and
the catalyst is the organocatalyst 1,8-Diazabicyclo[5.4.0]undec-7-ene (DBU), and
wherein the method also comprises addition of a modifying agent, and wherein the modifying agent is 1,4-butanediol.

20. The process according to claim 1, further comprising a melting step, wherein the 6-membered di-cyclic carbonate is melted, preferably the melting step is before the addition of polyamine and catalyst.

21. The process according to claim 20, wherein
the melting temperature of the melting step is 30° C. or higher, such as 60 or higher, 100° C. or higher, 140° C. or higher, or 180° C. or higher, and/or the melting temperature of the melting step is at least as high as the melting point of the 6-membered di-cyclic carbonate.

22. (canceled)

23. The process according to claim 1, wherein the reaction is solvent-free.

24. The process according to claim 1, wherein the reaction takes place in in solution, wherein the solution comprises an organic solvent, the organic solvent being selected from alcohols, cyclic ethers, ketones, toluene, acetonitrile, halogenated alkanes, dimethylformamide, and pyridine or mixtures thereof.

25. (canceled)

26. The process according to claim 1, wherein the polymerization is performed by means of molding, casting, coating, brown film or extrusion.

27. A random co-poly(urethane-carbonate), said random co-poly(urethane-carbonate) being obtainable by the process according to claim 1.

28.-30. (canceled)

31. An article comprising a random co-poly(urethane-carbonate) according to claim 27, wherein the article has been produced by blow moulding, injection moulding or sheet extrusion.

32. (canceled)
